(19) United States
(12) Patent Application Publication
(10) Pub. No.: US 2022/0072791 A1
(43) Pub. Date: Mar. 10, 2022

(54) DETERMINING A LIGHT SCATTERING PROPERTY OF AN OBJECT BASED ON TRANSMISSION VALUES OF THE OBJECT UNDER DIFFERENT MEASUREMENT CONDITIONS

(71) Applicant: Hewlett-Packard Development Company, L.P., Spring, TX (US)

(72) Inventors: Ingeborg Tastl, Palo Alto, CA (US); Melanie Gottwals, Palo Alto, CA (US)

(73) Assignee: Hewlett-Packard Development Company, L.P., Spring, TX (US)

(21) Appl. No.: 17/417,818

(22) PCT Filed: Mar. 29, 2019
(86) PCT No.: PCT/US2019/024888

§ 371 Date: Jun. 24, 2021

(51) Int. Cl. B29C 64/386; G01N 21/31; G06T 7/00; H04N 5/225; G06T 7/80; G05B 19/408; B33Y 50/00

(52) U.S. Cl. CPC B29C 64/386; G01N 21/31; G06T 7/001; H04N 5/2256; G05B 2219/45244; G05B 19/4083; B33Y 50/00; G06T 2207/10152; G05B 2219/49023; G06T 7/80

(57) ABSTRACT

An apparatus receives a first image of an object captured under a first light measurement condition and receives a second image of the object captured under a second light measurement condition. The apparatus determines a first transmission value of the object based on the first image, determines a second transmission value of the object based on the second image, and determines, based on a difference between the first transmission value and the second transmission value, a light scattering property of the object.

### BACKGROUND

Three dimensional (3D) printers can be used to print 3D objects. The 3D objects can either be prototypes for final products or fully functional objects or parts of objects that are being used in final products. The application areas for 3D objects range from the car and airplane industry to medical devices used for surgery, to prosthetics, to fixtures, and the like. 3D printers can print 3D objects in a variety of different ways. For example, some 3D printers can print 3D objects using an additive process and other 3D printers can print 3D objects using a subtractive process. 3D printers can print the 3D objects based on instructions obtained from a 3D model that is generated on a separate computer system. The instructions may control the dispensing of print material and agents from printheads on to a movable platform building the 3D object, for example, layer by layer.

### BRIEF DESCRIPTION OF THE DRAWINGS

FIG. 1 is a block diagram of an example system to calculate a correlation function of a camera;

FIG. 2 is a block diagram of an example apparatus for obtaining data to control a manufacturing apparatus;

FIG. 3 is a flow chart of an example method for calculating a correlation function;

FIG. 4 is a flow chart of an example method for controlling a manufacturing apparatus to manufacture an object using light transmission data that is calculated based on the correlation function;

FIG. 5 is a block diagram of an example non-transitory computer readable storage medium storing instructions and a processor to execute the instructions to calculate a light transmission percentage of an object to control a 3D printer to print the object.

FIGS. 6A-6C are illustrations of objects illuminated by a light source and reflecting or transmitting light, according to various examples;

FIGS. 7A-7B are illustrations of a sample holder accommodating a sample, according to an example;

FIG. 8 is an illustration of example transmission curves measured under various measurement conditions;

FIGS. 9A-9C are example illustrations of a sample placed on a light table;

FIG. 10 is a flow chart of an example method for controlling a manufacturing apparatus to manufacture an object based on a determination of a light scattering property according to a difference between two transmission values;

FIG. 11 is an illustration of an example apparatus for obtaining imaged transmission measurements to determine a degree of sub-surface scattering in a material to control a manufacturing apparatus; and

FIGS. 12A-12B are example configurations of an application server and manufacturing apparatus.

### DETAILED DESCRIPTION

Various examples of the disclosure will now be described with reference to the accompanying drawings, wherein like reference characters denote like elements. Examples to be explained in the following may be modified and implemented in various different forms.

When it is stated in the disclosure that one element is “connected to” or “coupled to” another element, the expression encompasses an example of a direct connection or direct coupling, as well as a connection with another element interposed therebetween. Further, when it is stated herein that one element “includes” another element, unless otherwise stated explicitly, it means that yet another element may be further included rather than being excluded.

Examples described herein include an apparatus and method to determine a light scattering property of an object, for example, in the context of manufacturing a product such as by 3D printing or injection molding. The apparatus and method can determine transmission values of an object using images of the object captured under different measurement conditions. Based on the transmission values, the apparatus and method can determine the light scattering property of the object. Information about the light scattering property can be used by a manufacturing apparatus to manufacture a product. The manufacturing apparatus can include a 3D printer or a device for performing injection molding, for example.

The color and the opacity of a 3D printed object may be determined by the printing material, the amount of agents that are being used, and the printing parameters of the printing process itself. A characterization process may be performed to establish the amount of agents to be used to achieve a specific color and/or opacity for manufacturing an object, for example by 3D printing. According to the disclosure, in the characterization process appearance attributes of samples of a specific size and thickness can be measured and the amount of agents can be systematically determined. Thus, the characterization process may enable accurate and efficient measurement of a large set of samples, for example samples for 3D printing.

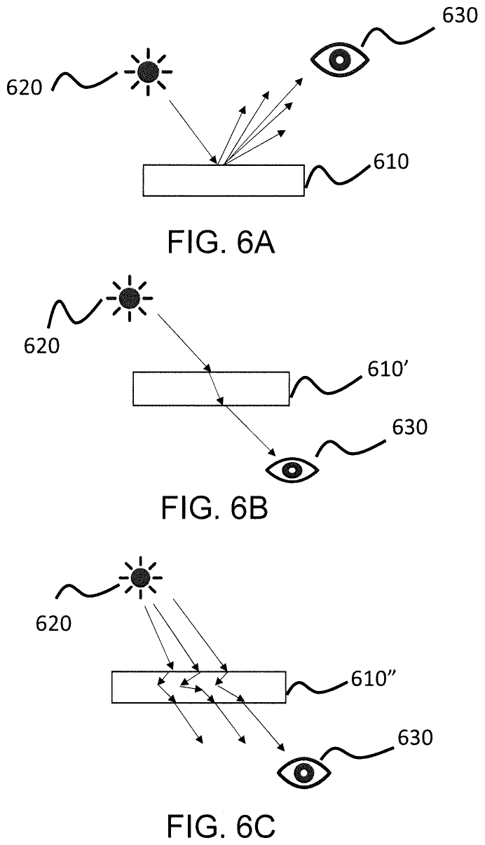

Generally, 3D printers can produce objects which are opaque or transparent in terms of appearance. FIGS. 6A-6C are illustrations of objects illuminated by a light source and reflecting or transmitting light, according to various examples. As illustrated in FIG. 6A, for opaque objects, such as a printed sheet of paper, when the opaque object 610 is illuminated by a light source 620 located at a same side of the object as an observer 630, most of the light is reflected to the observer 630. As illustrated in FIG. 6B, when a transparent object 610′ is illuminated by a light source 620 located at a side of the object 610′ opposite to an observer 630, most of light is transmitted through the object 610′ and perceived by the observer 630. As illustrated in FIG. 6C, sub-surface scattering is exhibited by object 610″ when illuminated by a light source 620.

The perceived appearance of an object can be quantified or measured so that the object can be manufactured or printed with a similar appearance, so that differences between the object to be reproduced and the manufactured object, if any, are not discernible or are less discernible to an observer.

Disclosed herein are example apparatuses and methods to distinguish between light that is directly transmitted by the material of an object and light that is at first scattered in the material of the object and then transmitted. The scattering within the material may be dependent on the microstructure and chemical composition of the material itself. This effect may be referred to as sub-surface scattering, which is illustrated in FIG. 6C as discussed above. Example materials that have a high degree of sub-surface scattering include porcelain, marble, skin, teeth, and the like.

An integrating sphere-based color measurement device can be used to measure light transmission properties. For example, in an integrating sphere-based color measurement device, a sample can be placed between a sample holder at the edge of the integrating sphere. Light from a light source passes through an opening, for example a circular opening, of an aperture of the sample holder facing the light source, through the sample itself, through the opening of the sample holder facing the integrating sphere, bounces around the integrating sphere and gets measured. Some amount of the light that is scattered in the material of the sample reaches a sensor of the measurement device (not shown), but some amount of the scattered light escapes to the side of the material. The diameter of the opening of the sample holder facing the integrating sphere may be smaller, for example 10 mm, than the opening of the sample holder, for example 13 mm, facing the light source. This configuration is referred to as over-illumination. During a measurement it can be observed that light leaks out on the sides due to the sub-surface scattering of the material. For translucent materials the measured transmission values are generally lower in comparison to visual observations.

If the same sample is placed on a light table that is much larger than the sample itself, illuminated from the back and either viewed by a human observer or measured with an instrument the following can be observed. First, some of the scattered light may come out on the sides of the sample. This is measurable as the amount of the measured light surrounding the sample is higher when a sample is present than when it is not. Second, light from the light table that is in proximity to the sample, but not directly underneath it can also enter the material of the sample and be transmitted towards the observer. This phenomenon is referred to as in-scattering. The visual impressions and measured values correlate better to one another compared to results obtained from the integrating sphere-based color measurement device.

To better characterize properties of a material for manufacturing an object by a manufacturing apparatus, obtaining knowledge of a degree of sub-surface scattering of the object, whether a relative measurement or an absolute measurement, may be useful. Materials might have a same amount of light that is directly transmitted but might differ in their sub-surface scattering characteristics. It may also be useful for determining manufacturing parameters of the object to be able to rank order or categorize materials as having no sub-surface scattering, low sub-surface scattering, or high sub-surface scattering.

Color measurement devices which perform transmission measurements mainly capture light that is directly transmitted through a material and capture a very small portion of the light that is scattered in the material and then transmitted. This may be acceptable for materials where the sub-surface scattering is negligible, for example tinted glass. However, for materials with a high amount of sub-surface scattering, for example marble, porcelain, teeth, and the like, transmission measurements by the measurement device may not correspond with the visual appearance. That is, the transmission measurements will be much lower than the perceived transmission by an observer.

Disclosed herein is an apparatus and method to obtain an indication of the degree of the scattered light for characterizing light scattering properties of a material that is to be produced by a manufacturing apparatus, for example, by a 3D printer for digital manufacturing.

In an example apparatus and method, transmission values of an object can be obtained using a digital camera for example. For example, a material to be measured can be placed on a light table, an image of the light transmitted through the object can be captured, the image can be converted into luminance information, and by using a calibration function, for example, a correlation function, the luminance values of the image can be transformed into absolute luminance information, for example in units of cd/m². The absolute luminance value of the object can be divided by absolute luminance values obtained by imaging the light table to obtain an imaged transmission value. For example, an imaged transmission value of 0% may indicate no transmission while an image transmission value of 100% may indicate that all the light is transmitted through the material.

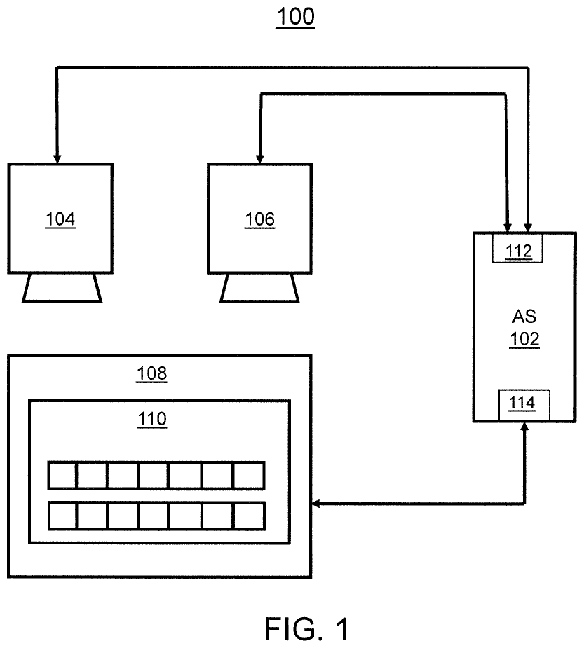

Described below with reference to FIGS. 1 through 5 are examples relating to apparatuses and methods for measuring the imaged transmission percentage of an object, for example the percentage of light that is transmitted through a material.

Expensive, dedicated color measurement devices can be used to measure the transmission percentage. These systems perform spot color measurements. Thus, the system uses a programmable x-y station and either the sensor or the samples are moved from spot to spot to perform the spot color measurement and then calculate the percentage of transmission. However, these kinds of color measurement devices can be expensive and the measurement process can be time consuming and inefficient.

As another example, according to the examples disclosed herein any type of vision camera can be used. The camera can be calibrated with a standard transmission chart on a light table to calculate a correlation function for the camera. The transmission percentage of an object may then be calculated by capturing an image of the object on the light table with the same camera and an image of the light table without the object. The red, green, blue (RGB) values of each pixel of the image can be converted into an absolute luminance value using the correlation function. Then, the transmission percentage at a particular location of the object may be calculated. For example, the transmission percentage at the location may be based on a comparison of the luminance value of the object at that location versus the luminance value of the corresponding position of the light table without the object.

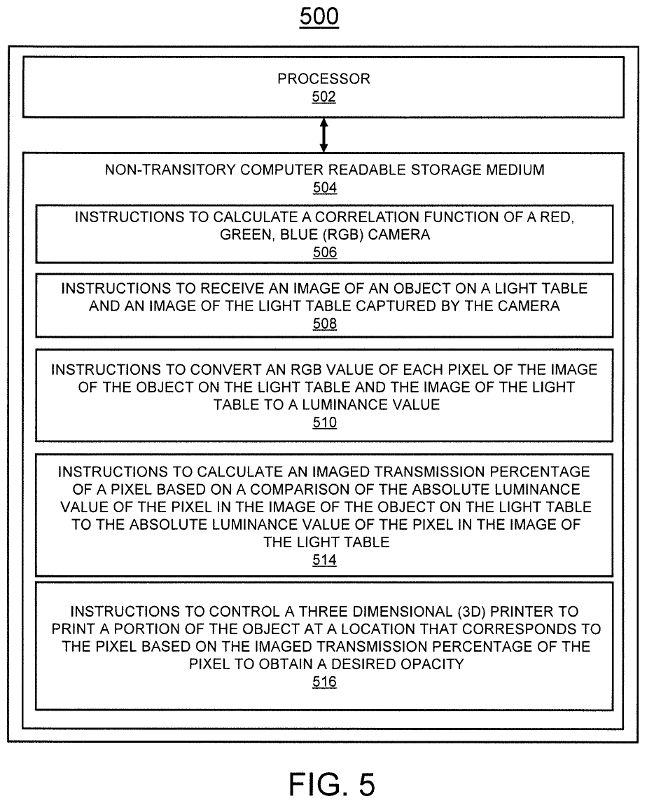

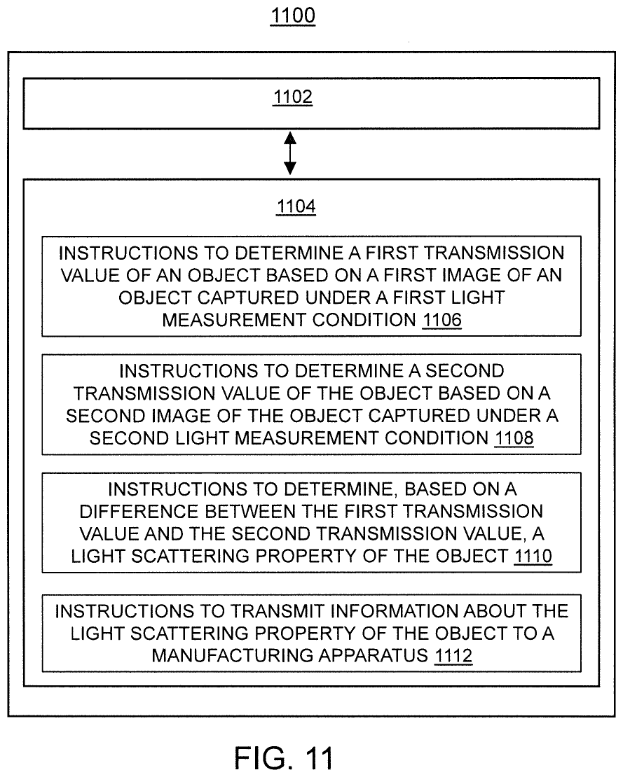

FIG. 1 illustrates an example of a system 100 to calculate a correlation function of a camera. In an example, the system 100 may include an application server (AS) 102, a camera 104, a tele-spectrophotometer 106, a light table 108, and a standardized transmission chart 110. The AS 102 may also include a receiver 112 to receive data and a transmitter 114 to transmit data. The receiver 112 and transmitter 114 may be separate components of the AS 102, or may be combined as a single component, for example in the form of a transceiver. The receiver 112 can be any device or structure that receives information via a wired and/or wireless network and can convert the information into a usable form. For example, the receiver 112 may include an integrated circuit within another device, and may include an antenna. The receiver 112 may include a hardware device such as a network interface controller or port, for example. The transmitter 114 can be any device or structure that transmits information via a wired and/or wireless network and can convert information into a usable form for transmission to another device. For example, the transmitter 114 may include an integrated circuit within another device, and may include an antenna. The transmitter 114 may include a hardware device such as a network interface controller or port, for example. The AS 102 may further include a controller or processor and memory which can perform various functions as described herein. The processor and memory included in the AS 102 may include or correspond to the processor 502, 1102 and memory 504, 1104 to be described later with reference to FIGS. 5 and 11. The memory may store data received via the receiver 112 from the camera 104 and the tele-spectrophotometer 106, data calculated by the processor, instructions to be executed by the processor to perform functions described herein, and the like.

The AS 102 may be communicatively coupled to the camera 104, the tele-spectrophotometer 106, and the light table 108, for example via a wired and/or wireless connection. The AS 102 may control operation of the camera 104, the tele-spectrophotometer 106, and the light table 108. For example, the AS 102 may instruct the camera 104 to capture images of the standardized transmission chart 110, control settings of the camera 104, and the like. The AS 102 may instruct the tele-spectrophotometer 106 to measure luminance values of different locations of the standardized transmission chart 110. The AS 102 may also turn the light table 108 on and off, control a brightness level of the light table 108, and the like.

The camera 104 may be any type of image capturing device. The camera 104 may be a red, green, blue (RGB) camera, a monochrome camera, a hyperspectral camera, and the like. The camera 104 may be any available camera such as a point and shoot camera, a camera on a mobile device, a camera on a tablet device, a camera on a laptop, a digital single lens reflex (DSLR) camera, a mirrorless camera, and the like. In other words, the camera 104 may be a widely available camera rather than a specialized expensive color measurement device.

The light table 108 may be positioned to be within a field of view of the camera 104. For example, the entire light table 108 may be within the field of view of the camera 104. In an example, the camera 104 may be positioned above the light table 108. For example, the camera 104 may be positioned above the light table 108 at approximately 90 degrees (e.g., a light ray emitted from the light table 108 may be 90 degrees relative to a surface of a lens of the camera 104).

The camera 104 may capture an image of the standardized transmission chart 110. The standardized transmission chart 110 may include a plurality of patches. For example, one row may have patches in increments from 10% light transmission to 100% light transmission. A second row may have patches in increments from 1% light transmission to 10% light transmission.

The image captured by the camera 104 may be analyzed to obtain RGB values for each pixel within an area of one of the light transmission windows of the standardized transmission chart 110. The camera 104 may capture the image at an appropriate camera exposure setting such that neither the dark areas nor the light areas are clipped. Other camera settings, such as gamma values, can be noted. The camera RGB values may then be converted into luminance values.

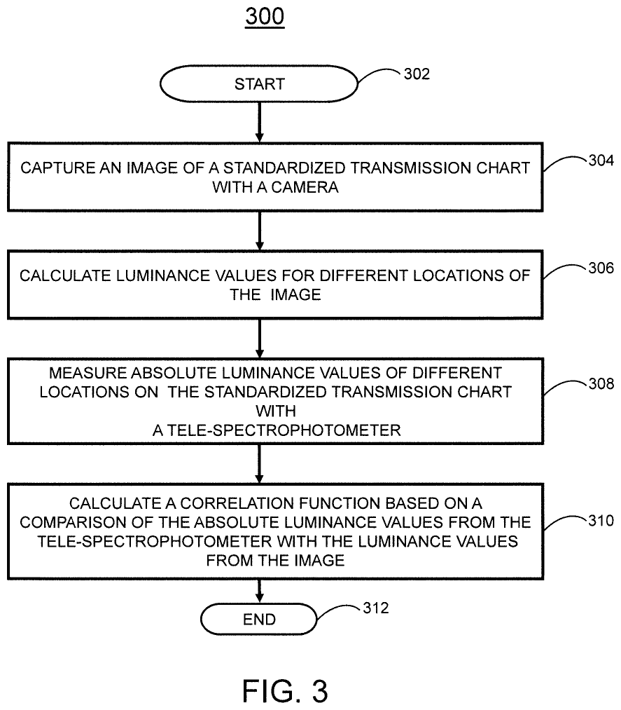

The tele-spectrophotometer 106 may be used to provide ground truth data. The measurement values, for example absolute luminance values, obtained by the tele-spectrophotometer 106 may be used to calculate a correlation function with the luminance values obtained from the image of the standardized transmission chart 108 captured by the camera 104. Further details on how the correlation function is obtained are discussed below with reference to FIG. 3.

The correlation function may be a function that converts the luminance values obtained based on the image capturing capabilities and/or settings of the camera 104 to the actual absolute luminance values obtained by the tele-spectrophotometer 106. As a result, any camera may be used by obtaining the correlation function for a particular camera. The correlation function may then be used to obtain appearance data from subsequent images captured by the camera 104. The appearance data may then be used in connection with generating instructions to control a manufacturing apparatus, for example to control a 3D printer to print objects with a consistent color appearance. The instructions may also be used to determine the amount of print agents and to set print parameters of the 3D printer to print the objects with a specific color and/or opacity.

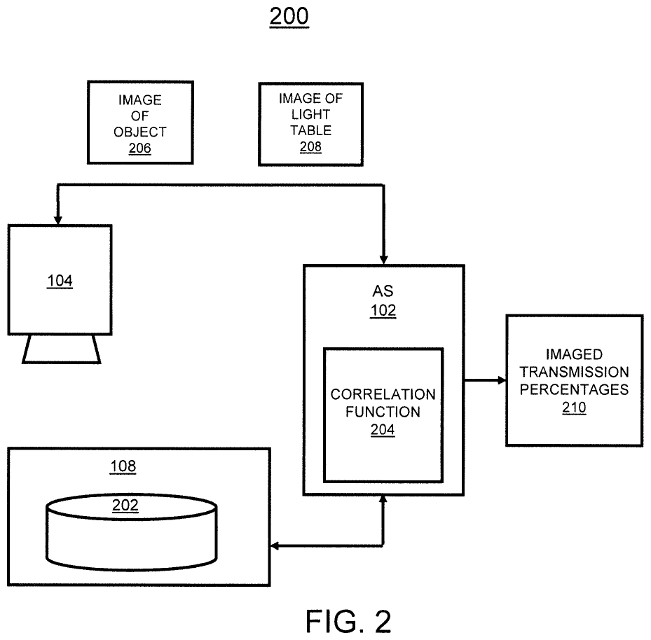

FIG. 2 illustrates an example apparatus 200 for obtaining appearance data to control a manufacturing apparatus, for example a 3D printer. The apparatus 200 provides hardware that may be independent of a specific hardware configuration to obtain color data/light transmission data of an object 202 that is to be manufactured, for example printed by a 3D printer.

The apparatus 200 may include the AS 102, the camera 104, and the light table 108. The AS 102 may be communicatively coupled to the camera 104 and the light table 108 via a wired and/or wireless connection. The AS 102 may control operations of the camera 104 and the light table 108, as described above. The AS 102 may include the receiver 112 and transmitter 114. The AS 102 may also include a controller or processor and memory which can perform the functions as described above in FIG. 1 and the functions as described in FIG. 2. The processor and memory included in the AS 102 may include the processor 502 and memory 504 to be described later with reference to FIG. 5.

The AS 102 may include a correlation function 204. For example, the correlation function 204 may be implemented by a computer program stored in the memory 504 and executed by the processor 502. The correlation function 204 may be applied to an image 206 captured by the camera 104 to calculate transmission percentages or values 210.

In one example, the term “transmission percentage” when used in reference to an image captured by the camera 104 may refer to an imaged transmission percentage. For example, the imaged transmission percentage refers to transmission measurements that are obtained using a camera and that have been corrected using the correlation function 204. The data may include light coming from the light table 108 that is directly transmitted through an object and light that is scattered within the material and captured by the camera.

For example, a three dimensional object 202 may be placed on the light table 108. The object 202 may be analyzed by the apparatus 200 to obtain transmission percentages 210. The transmission percentages 210 may be obtained for various locations of the object 202 to ensure that the object 202 is printed with consistent appearance. The transmission percentages 208 may ensure that each copy of the object 202 that is manufactured by a manufacturing apparatus, for example printed by a 3D printer, has a substantially similar appearance and/or color. The amount of light that is transmitted through each portion of the object 202 may affect the appearance of each portion of the object 202. If the amount of light that passes through each portion of the object 202 is not measured or quantified objectively, each copy of the object 202 may be printed with a slightly different appearance. Such an inconsistent appearance may be disfavored by a customer.

The image 206 of the object 202 on the light table 108 may be captured by the camera 104. The image 206 may be transmitted to the AS 102 for processing. As noted above, the correlation function 204 may be applied to the image 206 to obtain an accurate luminance value, for example an absolute luminance value, for each pixel of the image 206 adjusted for the characteristics of the camera 104.

Then the object 202 may be removed from the light table 108. The camera 104 may capture an image 208 of the light emitted by the light table 108 unhindered by the object 202. The image 208 of the light table 108 without the object 202 may be transmitted to the AS 102. The correlation function 204 may be applied to the image 208 to obtain luminance values, for example absolute luminance values, for each pixel of the image 208. Then for each pixel of the image 206 and 208 an imaged transmission percentage for the pixel may be calculated. The imaged transmission for each pixel from image 208 may be provided as percentages 210.

The imaged transmission percentages 210 can then be used to generate instructions used by a 3D printer to print an object 202. The objects that are printed can be different from the objects that are measured in the sense that a material sample is measured and then a specific 3D object is printed which is supposed to have the same appearance as the sample material. For example, the imaged transmission percentages 210 may be an electronic file or instructions that can be loaded into the 3D printer to determine print parameters for the object 202. For example, the imaged transmission percentages 210 may be converted into print instructions for each voxel of the object 202 during printing. For example, a particular transmission percentage at a pixel may correlate to a certain amount of print material of a particular color to obtain an appropriate appearance.

FIG. 3 illustrates a flow chart of an example method 300 for calculating a correlation function. The method 300 may be performed by the system 100, or by using the apparatus 500 illustrated in FIG. 5.

At block 302, the method 300 begins. At block 304, the method 300 captures an image of a standardized transmission chart with a camera. An example of the standardized transmission chart is described above and illustrated in FIG. 1. The camera may be any type of available RGB camera or monochromatic camera, as described above.

At block 306, the method 300 calculates luminance values for different locations of the image. For example, the luminance value for each different light transmission window of the standardized transmission chart may be calculated. In one example, an RGB value from the location of the image may be obtained. The RGB value may be converted into an image luminance value.

At block 308, the method 300 measures absolute luminance values of different locations on the standardized transmission chart with a tele-spectrophotometer. The tele-spectrophotometer may measure absolute luminance values in units of candelas per square meter (cd/m²). The absolute luminance values measured by the tele-spectrophotometer may provide an accurate baseline or ground truth data.

At block 310, the method 300 calculates a correlation function based on a comparison of the absolute luminance values from the tele-spectrophotometer with the luminance values from the image. For example, the luminance values from the image and the luminance values measured by the tele-spectrophotometer may be fitted to a curve or a polynomial function that may be obtained using any type of regression technique or polynomial fitting technique.

The function that is obtained may be the correlation function. The correlation function may be valid for a particular type of camera and any subsequent images captured by the camera. The correlation function may be valid also for a particular settings of the light table, the camera, and camera parameters used to capture the image (e.g., a focal distance, an exposure setting, and the like). The correlation function can be stored in a memory 504 of the AS 102, or an external memory, for future reference. The correlation function may be implemented in the form of a lookup table. The lookup table can be utilized, for example, with reference to particular cameras, particular settings, or a combination of factors including a type of camera and the settings utilized when deriving the correlation function. At block 312, the method 300 ends.

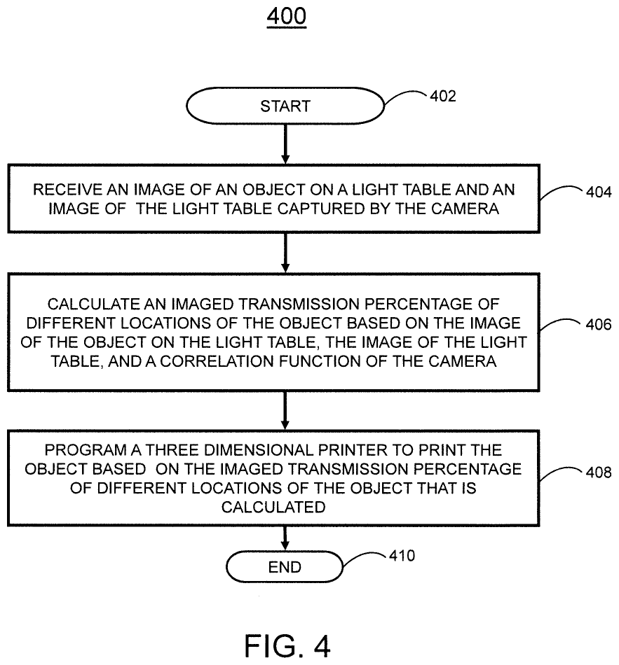

FIG. 4 illustrates a flow diagram of an example method 400 for controlling a manufacturing apparatus, for example a 3D printer to print an object, using light transmission data that is calculated based on the correlation function. For example, the method 400 may be performed by the apparatus 200, or the apparatus 500 illustrated in FIG. 5, and described below.

At block 402, the method 400 begins. At block 404, the method 400 receives an image of an object on a light table and an image of the light table captured by the camera. For example, the camera may capture the images in block 406 using the same parameters that were used by the camera to capture an image of the standardized transmission chart in the method 300. For example, the camera may be set to the same distance from the light table, set to the same exposure settings, set to the same viewing angle, and the like.

At block 406, the method 400 calculates an imaged transmission percentage of different locations of the object based on the image of the object on the light table, the image of the light table, and a correlation function of the camera. The correlation function of the camera may be calculated as described above and illustrated in FIG. 3. The correlation function may be previously stored in a memory of the AS 102 or an in an external memory.

For example, the RGB values of each pixel of both images may be converted into respective luminance values. The correlation function may be applied to convert luminance values obtained by the camera to obtain estimated absolute luminance values in units of cd/m², for example. The estimated absolute luminance value of a particular pixel of the image of the object on the light table may be divided by the estimated absolute luminance value of a corresponding pixel of the image of the light table to obtain an imaged transmission percentage for the pixel. The calculation may be repeated for each pixel, or specified pixels associated with the object, in the image of the object on the light table and the image of the light table.

For example, the image of the object on the light table and the image of the light table may be stored in an image format. A mask may be applied to both images to identify specific pixels of the object and stored in the form of an alpha channel (e.g., object pixels: alpha=1, background pixels: alpha=0). In another example, border pixels may be identified using image analysis and the border pixels may be excluded from calculating the imaged transmission percentage of the object.

For example, the imaged transmission percentages may be a function of a thickness of the material or the object. Thus, the thickness of the object may be noted when comparing the imaged transmission percentages for different copies of the object.

At block 408, the method 400 programs a three dimensional printer to print the object based on the imaged transmission percentage of different locations of the object that is calculated. For example, the imaged transmission percentages may be used to determine print parameters or print settings (e.g., an amount of print agent to be dispensed at each location of the object that is printed) on a 3D printer to print the object. In one example, the imaged transmission percentages may be loaded into the 3D printer and the 3D printer may calculate the necessary print parameters for each location or voxel of the object to be printed. In another example, the imaged transmission percentages may be converted into specific print instructions (e.g., set up instructions, G-code, and the like) that can be loaded onto the 3D printer and executed by the 3D printer.

For example, the print parameters may be an amount of printing agents or materials that are dispensed at a location during printing of the object. For example, the measured imaged transmission percentage may be used by a 3D printer to correlate the imaged transmission percentage at a location to an amount of printing agents or materials. The amount of print agents that is correlated to the imaged transmission percentage may be dispensed at the location to achieve an appropriate opacity. The portion of the object at the location may be printed with the correlated amount of print agents to have the appropriate opacity. For example, the control may be to either achieve a uniform opacity across an object or to achieve a specific opacity difference at different locations of the object.

In an example, the imaged transmission percentage at each location of the object may be set as a reference imaged transmission percentage to obtain the appropriate opacity. The reference imaged transmission percentage may be used as a process control for subsequently printed copies of the object. In an example, a threshold may be defined relative to the reference image transmission percentage (e.g., 1%, 5%, 10%, and the like). Thus, when a subsequent copy of the object is printed, the imaged transmission percentage at a location of the subsequently printed object may be compared to the reference imaged transmission percentage.

If the imaged transmission percentage at the location of the subsequently printed object is within the threshold compared to the reference imaged transmission percentage at the same location, then the object may be accepted. If the imaged transmission percentage at the location of the subsequently printed object lies outside of the threshold compared to the reference imaged transmission percentage at the same location, then the object may be rejected.

In one example, the imaged transmission percentage at different locations may be compared to the reference imaged transmission percentage of the corresponding different locations. If any of the imaged transmission percentages are outside of the threshold relative to the reference imaged transmission percentage at the different locations, then the subsequently printed object may be rejected.

While block 408 indicates a three dimensional printer is programmed, the disclosure is not so limited. Other types of manufacturing apparatuses, for example an injection molding machine, could be programmed to manufacture an object based on the imaged transmission percentage of different locations of the object that is calculated. At block 410, the method 400 ends.

FIG. 5 illustrates an example of an apparatus 500. In an example, the apparatus 500 may be the device 102, or may be included in the device 102. In an example, the apparatus 500 may include processor 502 and non-transitory computer readable storage medium 504. The non-transitory computer readable storage medium 504 may include instructions 506, 508, 510, 512, 514, and 516 that, when executed by the processor 502, cause the processor 502 to perform various functions.

In an example, the instructions 506 may include instructions to calculate a correlation function of a red, green, blue (RGB) camera. The instructions 508 may include instructions to receive an image of an object on a light table and an image of the light table captured by the camera. The instructions 510 may include instructions to convert an RGB value of each pixel of the image of the object on the light table and the image of the light table to a luminance value. The instructions 512 may include instructions to apply the correlation function to the luminance value to obtain an absolute luminance value. The instructions 514 may include instructions to calculate an imaged transmission percentage of a pixel based on a comparison of the absolute luminance value of the pixel in the image of the object on the light table to the absolute luminance value of the pixel in the image of the light table. The instructions 516 may include instructions to control a three dimensional (3D) printer to print a portion of the object at a location that corresponds to the pixel based on the image transmission percentage of the pixel to obtain an appropriate opacity. While instructions 516 indicates a 3D printer is controlled, the disclosure is not so limited. Other types of manufacturing apparatuses, for example an injection molding machine, could be controlled to manufacture an object based on the imaged transmission percentage.

As described above with reference to FIGS. 1 through 5, imaged transmission measurements can be obtained based on a correlation function. The imaged transmission measurements can vary depending on the size of the object placed on the light table. The percentage of the directly transmitted light may not change, but the light from the light table that is scattered out and into the object can change with the size of the object. An object-size independent measurement can be obtained according to the example apparatuses and methods disclosed herein which determine an indication of a degree of scattered light. The example apparatuses and methods disclosed herein can obtain measurements relating to an amount of scattering for various objects of different materials and sizes, and the materials can be ranked or categorized according to the amount of scattering that each material exhibits.

According to an example, a sample can be measured by masking light emitted from a light table. The light table can be masked, for example, by placing an opaque thin material underneath the object to be measured. A comparison of imaged transmission measurements obtained using masks of different sizes can provide an indication of the scattered light of the material.

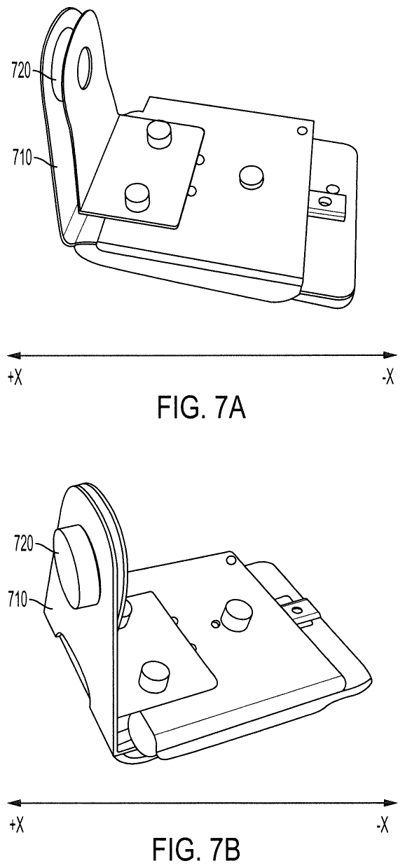

FIGS. 7A-7B are illustrations of a sample holder accommodating a sample, according to an example. FIG. 7A illustrates how a sample 720 can be placed within a sample holder 710. FIG. 7B illustrate how the sample 720 can be placed on an outside of the sample holder 710. The sample may be, for example, a white cylinder with a diameter of 23 mm and a thickness of 4 mm. Light transmission characteristics of the sample can be measured in a direct transmission mode with an integrating sphere color measurement device. Measurements using different detection apertures, for example apertures having a circular shape with a diameter of 6 mm, 10 mm, 17 mm or 25 mm, can be performed using the measurement device. The sample holder 710 can be placed inside the measurement device (not shown) with the illuminating light coming from one direction, the −x direction in FIGS. 7A-7B, and the light being transmitted through the sample 720 in the +x direction into an integrating sphere (not shown) and being measured by a sensor of the measurement device (not shown). As illustrated in FIGS. 7A-7B, the aperture of the sample holder 710 facing the illumination from the light source is greater than the aperture on the detection side, for example, 3 mm larger. This configuration provides an over-illumination of the sample 720. When samples that scatter light are measured by the measurement device, some of the scattered light escapes through the sides of the samples and is not accounted for in the measurements obtained by the measurement device. The amount of light that escapes through the sides of the sample can be quantified by comparing normal measurements with measurements where the sample itself is placed inside the integrating sphere.

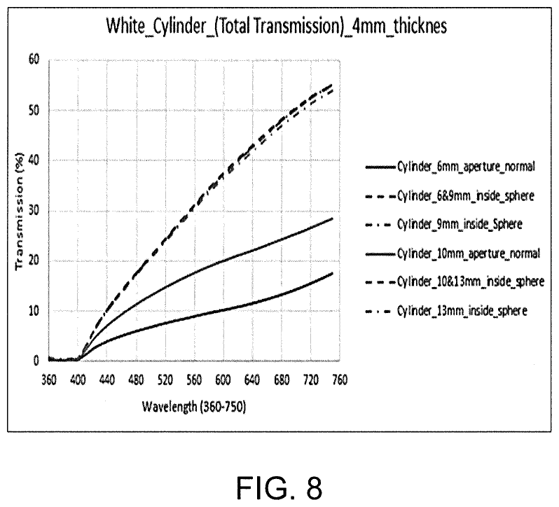

FIG. 8 is an illustration of transmission curves measured under various measurement conditions, according to an example. With reference to FIG. 8, the solid curves show the total transmission measurements for two different apertures (6 and 10 mm). The numbers are different from each other, indicating that transmission measurements for translucent materials may be dependent on the aperture size.

However, for materials that just transmit the light, for example tinted glass, the aperture size may not affect transmission measurements. In FIG. 8 there is a marked difference between the transmission percentage values obtained between samples measured in the normal mode and samples measured when they are placed inside the integrating sphere. In the case of an aperture of 6 mm the transmission is 3 times as high as the transmission measured in the normal mode (30% compared to 9%). In the case of a 10 mm aperture the factor is 1.7 but is still higher than the normal mode (29% compared to 17%). Thus, the results obtained as illustrated in FIG. 8 indicate that some of the light that is scattered in the material itself is not measured by the normal measurement mode of a measurement device.

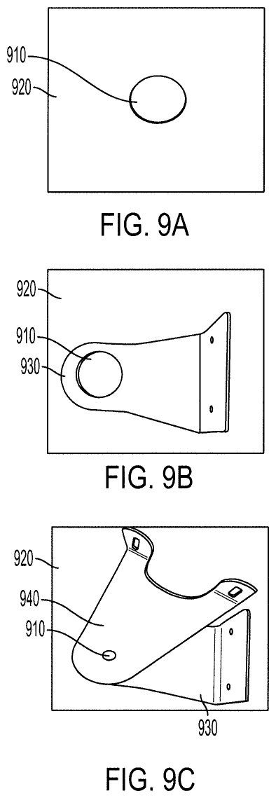

Illustrated in FIGS. 9A-9C are example configurations of a sample 910 placed on a light table 920. In FIG. 9A the sample 910 is placed on the light table 920 without a mask. In FIG. 9B a mask 930 is place on the light table 920 underneath the sample 910. Mask 930 has an aperture, for example of 13 mm. In FIG. 9C the sample 910 is placed between mask 930 and another mask 940. Mask 940 may have a different aperture size than that of the aperture of mask 930. For example, mask 940 may have a smaller aperture size, for example 10 mm.

Table 1 shown below compares measured transmission values from a tele-spectrophotometer with values from a camera and a measurement device. The sample is a white plastic cylinder (a PolyJet material) having a diameter of 23 mm and a thickness of 4 mm. The transmission values shown in Table 1 for the camera are not calibrated by way of the correlation function for the tele-spectrophotometer. That is, the data in Table 1 are camera luminance values and not absolute luminance values. The three rows compare different measurement conditions. Similar to the results discussed above with respect to FIG. 8, the results shown in Table 1 indicate that transmission values can vary for a translucent material depending on a size of the aperture.

TABLE 1

| | First Measurement | | Second |
|---|---|---|---|
| | Device (tele- | | Measurement |
| | spectrophotometer) | Camera | Device |
| | Transmission | Transmission | Transmission |
| Aperture | (%) | (%) | (%) |
| No Aperture | 33.62 | 33.87 | 29.00 |
| Detection 6 mm | 10.24 | 13.00 | 9.00 |
| Illum 9 mm | | | |
| Detection 10 mm | 20.46 | 17.40 | 17.00 |
| Illum 13 mm | | | |

Table 2 shown below compares measured transmission values from a tele-spectrophotometer with values from a camera and a measurement device. The sample is a white plastic cube having a side length of 40 mm and a thickness of 4 mm. The material of the white plastic cube is the same as that of the white plastic cylinder discussed above with respect to Table 1. The transmission values shown in Table 2 for the camera are not calibrated by way of the correlation function for the tele-spectrophotometer. That is, the data in Table 2 are camera luminance values and not absolute luminance values. The three rows compare different measurement conditions. Similar to the results discussed above with respect to FIG. 8, the results shown in Table 2 again indicate that transmission values can vary for a translucent material depending on a size of the aperture. The results of Table 2 are also the same as the results of Table 1 when an aperture is utilized. However, when no aperture is utilized, the transmission values can vary depending on a size of the object.

TABLE 2

| | First Measurement | | Second |
|---|---|---|---|
| | Device (tele- | | Measurement |
| | spectrophotometer) | Camera | Device |
| | Transmission | Transmission | Transmission |
| Aperture | (%) | (%) | (%) |
| No Aperture | 45.20 | 44.37 | — |
| Detection 6 mm | 10.79 | 13.05 | 9.00 |
| Illum 9 mm | | | |
| Detection 10 mm | 20.64 | 17.72 | 17.00 |
| Illum 13 mm | | | |

Based on the above results, the following observations can be made. First, transmission measurements may be dependent on the thickness of the sample. Thus, measurement values may vary according to the thickness of the measured samples, and when comparing a transmission value for a first material with a transmission value for a second material, for reasons of comparison the first material and second material may have a same thickness.

Second, the transparency of samples may depend on a size of the measurement aperture. For translucent materials a larger aperture results in larger transmission values. For samples that do not scatter incoming light, variations in aperture size may not affect a transmission value. Thus, when comparing a transmission value for a first material with a transmission value for a second material, the measurements of the transmission values for the first material and the second material may utilize a same aperture size so that like measurement conditions are utilized. Transmission measurements obtained without any aperture may be used for comparative reasons, for example, the same objects manufactured in different ways may be compared with each other.

Third, comparing transmission measurements with different apertures gives an indication of the amount of scattered light of the material. If the difference between the transmission values obtained using different aperture sizes is small, the amount of scattered light is small.

Fourth, comparing results of the transmission measurements without any apertures/masks with transmission measurements with the apertures/masks may be less indicative of the amount of sub-scattering of the material in the sense that transmission measurements obtained without any apertures/masks may depend on the size and geometry of the sample itself.

For materials with a low degree of sub-surface scattering the transmission values, the differences between the transmission measurements measured using different apertures is not significant. For example, shown below in Table 3 are transmission measurement results obtained using a measurement device for a glass slide having a size of 75 mm×50 mm. As can be seen from Table 3, the difference between the transmission percentage values obtained under different aperture settings is 0.4%.

TABLE 3

| | Measurement |
|---|---|
| | Device |
| Aperture | Transmission (%) |
| Detection 6 mm | 91.24 |
| Illum 9 mm | |
| Detection 10 mm | 91.64 |
| Illum 13 mm | |

As another example, shown below in Table 4 are transmission measurement results obtained using a measurement device for different colored coasters manufactured from a temperature and scratch resistant TPU material and having a thickness of 3 mm and a diameter of 95 mm. As can be seen from Table 4, the difference between the transmission percentage values obtained under different aperture settings is less than 3% in each case.

TABLE 4

| | Measurement | | |
|---|---|---|---|
| | Device Transmission | Measurement Device | |
| | (%) | Transmission (%) | Change in |
| Aperture | 6 & 9 mm aperture | 25 & 28 mm aperture | Transmission |
| Orange | 40.15 | 42.53 | 2.38 |
| Coaster | | | |
| Red | 17.79 | 19.39 | 1.6 |
| Coaster | | | |
| Blue | 18.60 | 19.78 | 1.18 |
| Coaster | | | |
| Green | 28.79 | 31.16 | 2.37 |
| Coaster | | | |
| Gray | 33.81 | 35.76 | 1.95 |
| Coaster | | | |

As another example, shown below in Table 5 are transmission measurement results obtained using a measurement device for four different colored RAL plastic reference samples. As can be seen from Table 5, the difference between the transmission percentage values obtained under different aperture settings is less than 4% in each case.

TABLE 5

| | First Measurement | Second Measurement | |
|---|---|---|---|
| | Device Transmission | Device Transmission | |
| | (%) | (%) | Change in |
| Aperture | 6 & 9 mm aperture | 25 & 28 mm aperture | Transmission |
| Gray | 39.68 | 42.43 | 2.75 |
| sample | | | |
| Magenta | 12.75 | 15.35 | 2.6 |
| sample | | | |
| Yellow | 49.97 | 53.39 | 3.42 |
| sample | | | |
| Cyan | 26.04 | 27.38 | 1.34 |
| sample | | | |

In contrast to the small differences in transmission values obtained between the 6 mm and 25 mm apertures used in connection with the colored coasters and RAL plastic reference samples obtained in Tables 4 and 5, the difference in transmission values obtained in Tables 1 and 2 for the PolyJet material was significantly higher (8%). Thus, there is a clear difference due to the light transportation within the different materials.

In view of the results discussed above, example apparatuses and methods for imaged transmission measurements which describe the contribution of the light that is scattered in the material before being transmitted are described below.

Unlike the color measurements for surface reflectance, transmission measurements may be dependent on the sample thickness. Plastic reference samples used in the plastics industry may have a thickness of 1 mm, 2 mm, 4 mm, and the like. The percentage of transmission may go down with an increase in the thickness of a material, for example for translucent materials. For comparative reasons when measuring transmission properties, a same thickness of a material measured under different measurement conditions may be used.

FIG. 2 illustrates an example apparatus 200 for obtaining imaged transmission measurements to determine a degree of sub-surface scattering in a material to control a manufacturing apparatus, for example a 3D printer, according to the examples described herein.

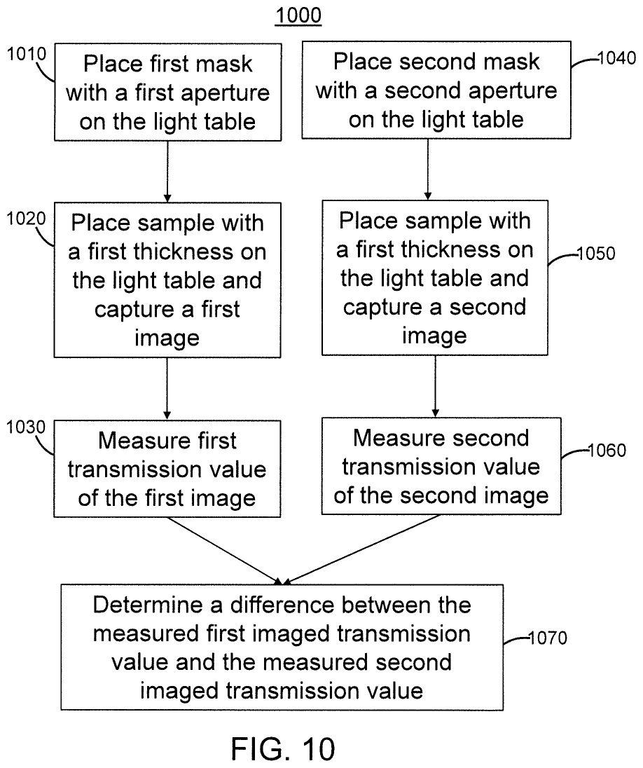

The apparatus 200 may include the AS 102, the camera 104, and the light table 108. The AS 102 may include the receiver 112 and transmitter 114. The AS 102 may also include a controller or processor and memory which can perform the functions as described above in FIGS. 1 and 2 and the functions described in FIGS. 10 and 11 described below. According to the examples described herein, the receiver 112 can receive a first image of an object captured under a first light measurement condition, and a second image of an object captured under a second light measurement condition. For example, the first light measurement condition may include capturing the object, by the camera 104, while the object is positioned on a first mask on a light table 108. The first mask may have a first aperture of a first size, for example 25 mm. The second light measurement condition may include capturing the object, by the camera 104, while the object is positioned on a second mask on the light table 108. The second mask may have a second aperture of a second size, for example 6 mm.

The processor of the AS 102 can determine a first transmission value of the object based on the first image, determine a second transmission value of the object based on the second image, and determine, based on a difference between the first transmission value and the second transmission value, a light scattering property of the object.

For example, when the difference between the first transmission value and the second transmission value is greater than a predetermined threshold value, the processor may determine the light scattering property of the object exhibits sub-surface scattering of light within the object. For example, when the difference between the first transmission value and the second transmission value is greater than the predetermined threshold value, the processor can categorize the object as having a high degree of sub-surface scattering, and when the difference between the first transmission value and the second transmission value is less than the predetermined threshold value, the processor can categorize the object as having a low degree of sub-surface scattering or as having no sub-surface scattering.

As another example, the processor of the AS 102 can rank the light scattering property of the object relative to a light scattering property of another object based on the difference between the first transmission value and the second transmission value.

The processor of the AS 102 can control the transmitter 114 to transmit information about the light scattering property of the object to a manufacturing apparatus. The information about the light scattering property of the object can be used by the manufacturing apparatus to manufacture a product. The manufacturing apparatus can determine an amount and/or type of a material to be used to manufacture the product or to modify manufacturing parameters for the product based on the information about the light scattering property of the object. For example, the manufacturing apparatus can include a 3D printer, an injection molding machine, and the like.

For example, the information about the light scattering property may include instructions to control the manufacturing apparatus to manufacture the product based on the light scattering property so that a translucency of the product matches a translucency of the sample object.

The first transmission value of the object and the second transmission value of the object can be determined based on the apparatuses and methods described herein with respect to FIGS. 1 through 5. For example, the processor can determine the first transmission value of the object by calculating a first imaged transmission percentage based on a comparison of a transformed luminance value of the first image of the object obtained using the correlation function with a transformed luminance value of an image of the light table obtained using the correlation function. The processor can determine the second transmission value of the object by calculating a second imaged transmission percentage based on a comparison of a transformed luminance value of the second image of the object obtained using the correlation function with the transformed luminance value of the image of the light table obtained using the correlation function.

FIG. 10 illustrates an example method 1000 for obtaining imaged transmission measurements to determine a degree of sub-surface scattering in a material to control a manufacturing apparatus, for example a 3D printer, according to the examples described herein.

As illustrated in FIG. 10, a first mask having an aperture of a first size is placed on a light table at block 1010. For example, the first mask may have an aperture of 25 mm. At block 1020 a first sample having a first thickness is placed on top of the first mask and a first image of the first sample while the first sample is placed on the first mask is captured by a camera. The measurement conditions under which the first image are captured may be described by a size of the aperture of the first mask, and can be described as a first measurement condition. A first transmission value of the first sample is then measured or obtained according to the first measurement condition at block 1030.

For example, the imaged transmission percentage of the first sample can be obtained as the first transmission value according to the example apparatuses and methods described above with respect to FIGS. 1 through 5. For example, in addition to capturing a first image of the first sample at block 1020, an image of the light emitted by the light table without the first sample placed on the light table having the first mask placed thereon may be captured, in a manner similar to block 404 from FIG. 4. Then, the correlation function can be applied to each of the first image and the image of the light table having the first mask placed thereon, to obtain respective absolute luminance values. The first transmission value may be an imaged transmission percentage which is determined by dividing the absolute luminance values of the first image by the absolute luminance values of the image of the light table having the first mask placed thereon. As another example, a transmission percentage of the first sample can be obtained using luminance values that are not calibrated using the correlation function described herein.

In block 1040 of FIG. 10, a second mask having an aperture of a second size is placed on the light table. For example, the second mask may have an aperture of 6 mm. At block 1050 the first sample having the first thickness is placed on top of the second mask and a second image of the first sample while the first sample is placed on the second mask is captured by a camera. The measurement conditions under which the second image are captured may be described by a size of the aperture of the second mask, and can be described as a second measurement condition. A second transmission value of the first sample is then measured or obtained according to the second measurement condition at block 1060.

For example, the imaged transmission percentage of the first sample can be obtained as the second transmission value according to the method described above with respect to FIGS. 1 through 5. For example, in addition to capturing a second image of the first sample at block 1050, an image of the light emitted by the light table without the first sample placed on the light table having the second mask placed thereon may be captured, in a manner similar to block 404 from FIG. 4. Then, the correlation function can be applied to each of the second image and the image of the light table having the second mask placed thereon, to obtain respective absolute luminance values. The second transmission value may be an imaged transmission percentage which is determined by dividing the absolute luminance values of the second image by the absolute luminance values of the image of the light table having the second mask placed thereon. As another example, a transmission percentage of the second sample can be obtained using luminance values that are not calibrated using the correlation function described herein.

As discussed above the first sample is measured under both the first and second measurement conditions. It is also possible that a second sample, having a same material and a same thickness as the first sample, may be used instead of the first sample to obtain the second transmission value according to the second measurement condition. Blocks 1010 through 1060 may be performed sequentially. As another example, some or all of blocks 1010 through 1030 may be performed in parallel with some or all of blocks 1040 through 1060.

At block 1070, a difference between the first transmission value and the second transmission value is obtained. A magnitude of the difference between the first transmission value and the second transmission value can indicate a degree of scattered light in the material.

For example, if the difference is greater than a first predetermined threshold value, then the material may be categorized as having a high degree of sub-surface scattering. If the difference is less than the first predetermined threshold value, then the material may be categorized or ranked as having a low degree of sub-surface scattering. For example, the first predetermined threshold value may be a difference of 5%.

As another example, more than one threshold value may be utilized to describe, rank, or categorize degrees of sub-surface scattering for a material relative to other materials. For example, if the difference is greater than a first predetermined threshold value then the material may be categorized as having a high degree of sub-surface scattering. If the difference is less than the first predetermined threshold value but greater than a second predetermined threshold value, then the material may be ranked or categorized as having a low degree of sub-surface scattering. If the difference is less than both the first predetermined threshold value and the second predetermined threshold value, then the material may be ranked or categorized as having no sub-surface scattering. For example, the first predetermined threshold value may be a difference of 7% and the second predetermined threshold value may be a difference of 3%.

The different number of threshold values are examples, and more than two threshold values may be utilized to describe, rank, or categorize degrees of sub-surface scattering for a material relative to other materials. For example, the degree of sub-surface scattering for different materials may be categorized using an ordinal scale which orders the materials from no sub-surface scattering to a high degree of sub-surface scattering. Also, the threshold values given are examples and other values may be utilized to describe, rank, or categorize a degree of sub-surface scattering for a material relative to other materials.

The mask may be implemented in various forms. For example, the aperture of the mask may be circular in shape. However, the mask can have other shapes, for example triangular, polygonal, and the like. Also, a size of the aperture of the mask can be varied, though signal strength and noise may affect a size of the aperture to be selected. Other variations are also possible. For example, a point light source such as a laser light, flash light from a phone, and the like, may be implemented instead of a light table.

FIG. 11 illustrates an example apparatus 1100 for obtaining imaged transmission measurements to determine a degree of sub-surface scattering in a material to control a manufacturing apparatus, for example a 3D printer, according to the examples described herein.

In an example, the apparatus 1100 may be the device 500, device 102, or may be included in the device 102. In an example, the apparatus 1100 may include processor 1102 and non-transitory computer readable storage medium 1104. The processor 1102 and non-transitory computer readable storage medium 1104 may correspond to processor 502 and non-transitory computer readable storage medium 504 discussed above with respect to FIG. 5. The non-transitory computer readable storage medium 1104 may include instructions 1106, 1108, 1110, and 1112 that, when executed by the processor 1102, cause the processor 1102 to perform various functions.

The instructions 1106 include instructions to determine a first transmission value of an object based on a first image of an object captured under a first light measurement condition. The instructions 1108 include instructions to determine a second transmission value of the object based on a second image of the object captured under a second light measurement condition. The instructions 1106 may determine the first transmission value of the object by calculating a first transmission percentage based on the correlation function disclosed herein. The instructions 1108 may also determine the second transmission value of the object by calculating a second transmission percentage based on the correlation function.

The instructions 1110 include instructions to determine, based on a difference between the first transmission value and the second transmission value, a light scattering property of the object.

The instructions 1112 include instructions to transmit information about the light scattering property of the object to a manufacturing apparatus. The information about the light scattering property of the object can be used by the manufacturing apparatus to manufacture a product.

Additional instructions may be stored on the non-transitory computer readable storage medium 1104. For example, non-transitory computer readable storage medium 1104 may include instructions to determine the light scattering property of the object as including sub-surface scattering of light within the object, when the difference between the first transmission value and the second transmission value is greater than a predetermined threshold.

For example, non-transitory computer readable storage medium 1104 may include instructions, to when the difference between the first transmission value and the second transmission value is greater than a predetermined threshold value, determine the light scattering property of the object by categorizing the object as having a high degree of sub-surface scattering, and when the difference between the first transmission value and the second transmission value is less than the predetermined threshold value, determine the light scattering property of the object by categorizing the object as having a low degree of sub-surface scattering or as having no sub-surface scattering.

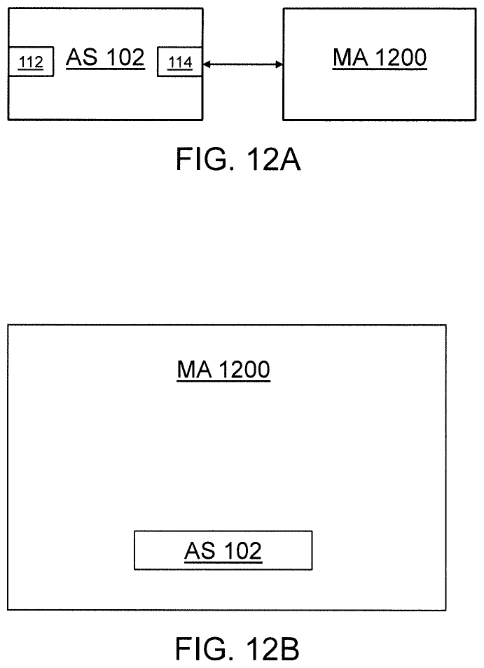

FIG. 12A illustrates an example of AS 102 in communication with a manufacturing apparatus (MA) 1200. The AS 102 can communicate with the manufacturing apparatus 1200 over a wired and/or wireless network. FIG. 12B illustrates an example of AS 102 being embedded or integrated within manufacturing apparatus 1200. As another example, device 102 may be implemented as an external device other than an application server. For example, device 102 may be an external device including a personal computer, a laptop, a tablet, a smartphone, a server, or combinations thereof.

An imaged transmission measurement for the first and second transmission values can be, for example, a representative value of an average over an area of the image, a statistical distribution of the image, or values of each pixel/voxel of the image. Thus, light scattering properties of the object can be determined on a per voxel basis, or based on the object as a whole. Utilizing a single number to categorize sub-surface scattering properties of an object may be useful for comparing different materials. Having data in the form of images or distributions that are obtained by the image captured by the camera may also identify potential non-uniformities in an object which can result from different manufacturing conditions and/or fusing/cooling rates.

According to the above-described examples, transmission measurements which include directly transmitted as well as scattered light can be obtained. These transmission measurements correspond well with the transmission of light of an object that is perceived by a human observer. By performing two measurements, one with a mask of a first size placed underneath the object and another with a mask of a second size placed underneath the object, the contribution of scattered light that is included in the imaged transmission measurements can be determined and controlled. The use of different masks with different apertures can be conveniently and flexibly performed, and the measurements can be obtained in an efficient manner.

A comparison of the luminous transmission measurements obtained with two different masks according to the examples disclosed herein can provide an indication of the amount of scattered light. The result of the comparison is a relative measure by which materials can be compared. Materials can be categorized and rank ordered in terms of the degree of sub-surface scattering. Printing processes and amount of agents to be used in a manufacturing process can be modified in order to increase or decrease the degree of scattering so as to produce a product having the same or substantially the same degree of transparency as the object to be replicated.

According to the examples disclosed herein, there may be less restrictions on the size, shape, and weight of the samples that can be measured in contrast to color measurement devices. Furthermore, according to the examples disclosed herein, the complexity of the method may be reduced compared to methods utilizing color measurement devices. For example, the use of clamps can be omitted because samples need not be clamped between a sample holder as in methods utilizing color measurement devices. Furthermore, placing the camera on an x-y station for capturing images of the samples according to the examples disclosed herein can be automatized and many samples can be measured in an efficient way. According to the examples disclosed herein process control can also be easily implemented by setting and checking different threshold values to ensure a quality of a manufactured product meets specifications and expectations.

The processors and controllers described herein may include any of a processor, an arithmetic logic unit, a central processing unit (CPU), a graphics processing unit (GPU), a digital signal processor (DSP), an image processor, a microcomputer, a field programmable array, a programmable logic unit, an application-specific integrated circuit (ASIC), a microprocessor, or combinations thereof.

The non-transitory computer readable storage media described herein may include any electronic, magnetic, optical, or other physical storage device that stores executable instructions. For example, the non-transitory computer readable storage medium 504 may include a nonvolatile memory device, such as a Read Only Memory (ROM), Programmable Read Only Memory (PROM), Erasable Programmable Read Only Memory (EPROM), and flash memory, a USB drive, a volatile memory device such as a Random Access Memory (RAM), a hard disk, floppy disks, a blue-ray disk, or optical media such as CD ROM discs and DVDs, or combinations thereof.

Executable instructions to perform processes or operations in accordance with the above-described examples may be recorded in a machine readable storage. A controller or processor may execute the executable instructions to perform the processes or operations. Examples of instructions include both machine code, such as that produced by a compiler, and files containing higher level code that may be executed by the controller using an interpreter. The instructions may be executed by a processor or a plurality of processors included in the controller. The machine readable storage may be distributed among computer systems connected through a network and computer-readable codes or instructions may be stored and executed in a decentralized manner.

The foregoing examples are merely examples and are not to be construed as limiting the disclosure. The disclosure can be readily applied to other types of apparatuses. Various modifications may be made which are also intended to be encompassed by the disclosure. Also, the description of the examples of the disclosure is intended to be illustrative, and not to limit the scope of the claims.

What is claimed is:

1. An apparatus, comprising:
a receiver to receive a first image of an object captured under a first light measurement condition and to receive a second image of the object captured under a second light measurement condition; and
a processor to:
determine a first transmission value of the object based on the first image,
determine a second transmission value of the object based on the second image, and
determine, based on a difference between the first transmission value and the second transmission value, a light scattering property of the object.

2. The apparatus of claim 1, wherein
the first light measurement condition includes capturing the object, by a camera, while the object is positioned on a first mask on a light table, the first mask having a first aperture of a first size, and
the second light measurement condition includes capturing the object, by the camera, while the object is positioned on a second mask on the light table, the second mask having a second aperture of a second size.

3. The apparatus of claim 1, wherein when the difference between the first transmission value and the second transmission value is greater than a predetermined threshold value, the processor is to determine the light scattering property of the object as having sub-surface scattering of light within the object.

4. The apparatus of claim 1, wherein the processor is to rank the light scattering property of the object relative to a light scattering property of another object based on the difference between the first transmission value and the second transmission value.

5. The apparatus of claim 1, wherein
when the difference between the first transmission value and the second transmission value is greater than a predetermined threshold value, the processor is to determine the light scattering property of the object by categorizing the object as having a high degree of sub-surface scattering, and
when the difference between the first transmission value and the second transmission value is less than the predetermined threshold value, the processor is to determine the light scattering property of the object by categorizing the object as having a low degree of sub-surface scattering or as having no sub-surface scattering.

6. The apparatus of claim 1, further comprising a transmitter to transmit information about the light scattering property of the object to a manufacturing apparatus, and the information about the light scattering property including instructions to control the manufacturing apparatus to manufacture a product based on the light scattering property so that a translucency of the product matches a translucency of the object.

7. A system, comprising:
a light table to accommodate an object, to emit light towards the object under a first light measurement condition, and to emit light towards the object under a second light measurement condition;
a camera to capture a first image of the object under the first measurement condition and to capture a second image of the object under the second measurement condition; and
a controller to:
determine a first transmission value of the object based on the first image, and a second transmission value of the object based on the second image, and
determine, based on a difference between the first transmission value and the second transmission value, a light scattering property of the object.

8. The system of claim 7, wherein
the first measurement condition includes capturing the object, by the camera, while the object is positioned on a first mask on the light table, the first mask having a first aperture of a first size, and
the second measurement condition includes capturing the object, by the camera, while the object is positioned on a second mask on the light table, the second mask having a second aperture of a second size.

9. The system of claim 7, wherein the controller is to:
determine a correlation function of the camera based on a comparison between a luminance value of an image captured by the camera of a standardized transmission chart positioned on the light table and a luminance value of the standardized transmission chart positioned on the light table captured by a tele-spectrophotometer,
determine the first transmission value of the object by calculating a first imaged transmission percentage based on a comparison of a transformed luminance value of the first image of the object obtained using the correlation function with a transformed luminance value of an image of the light table obtained using the correlation function, and
determine the second transmission value of the object by calculating a second imaged transmission percentage based on a comparison of a transformed luminance value of the second image of the object obtained using the correlation function with the transformed luminance value of the image of the light table obtained using the correlation function.

10. The system of claim 7, wherein
when the difference between the first transmission value and the second transmission value is greater than a predetermined threshold value, the controller is to determine the light scattering property of the object by categorizing the object as having a high degree of sub-surface scattering, and
when the difference between the first transmission value and the second transmission value is less than the predetermined threshold value, the controller is to determine the light scattering property of the object by categorizing the object as having a low degree of sub-surface scattering or as having no sub-surface scattering.

11. The system of claim 7, further comprising a manufacturing apparatus,
wherein the controller is to transmit information about the light scattering property of the object to the manufacturing apparatus,
the manufacturing apparatus is to determine at least one of an amount or type of a material or agent to be used to manufacture a product or to modify manufacturing parameters for the product based on the information about the light scattering property of the object, and
the manufacturing apparatus includes at least one of a three dimensional printer or an injection molding apparatus.

12. A non-transitory machine readable storage comprising instructions that when executed cause a processor to:
determine a first transmission value of an object based on a first image of an object captured under a first light measurement condition;
determine a second transmission value of the object based on a second image of the object captured under a second light measurement condition; and
determine, based on a difference between the first transmission value and the second transmission value, a light scattering property of the object.

13. The non-transitory machine readable storage of claim 12, wherein the non-transitory machine readable storage further comprises instructions that when executed cause the processor to:
determine the light scattering property of the object as including sub-surface scattering of light within the object, when the difference between the first transmission value and the second transmission value is greater than a predetermined threshold value.

14. The non-transitory machine readable storage of claim 12, wherein the non-transitory machine readable storage further comprises instructions that when executed cause the processor to:
when the difference between the first transmission value and the second transmission value is greater than a predetermined threshold value, determine the light scattering property of the object by categorizing the object as having a high degree of sub-surface scattering, and
when the difference between the first transmission value and the second transmission value is less than the predetermined threshold value, determine the light scattering property of the object by categorizing the object as having a low degree of sub-surface scattering or as having no sub-surface scattering.

15. The non-transitory machine readable storage of claim 12, wherein the non-transitory machine readable storage further comprises instructions that when executed cause the processor to:
determine a correlation function of a camera used to capture the first image and the second image, based on a comparison between a luminance value of an image captured by the camera of a standardized transmission chart positioned on a light table and a luminance value of an image of the standardized transmission chart positioned on the light table captured by a tele-spectrophotometer,
determine the first transmission value of the object by calculating a first transmission percentage based on the correlation function, and
determine the second transmission value of the object by calculating a second transmission percentage based on the correlation function.
